(19) United States
(12) Patent Application Publication
(10) Pub. No.: US 2021/0325918 A1
(43) Pub. Date: Oct. 21, 2021

(54) THERMOSTATIC MIXER WITH SINGLE CONTROL LEVER

(71) Applicant: ARTIS S.R.L., Collebeato (BS) (IT)

(72) Inventor: Giordano OTTELLI, Collebeato (BS) (IT)

(73) Assignee: ARTIS S.R.L., Collebeato (BS) (IT)

(21) Appl. No.: 17/272,075

(22) PCT Filed: Sep. 2, 2019
(86) PCT No.: PCT/IB2019/057379

§ 371 Date: Feb. 26, 2021

(30) Foreign Application Priority Data
Sep. 3, 2018 (IT) 102018000008307

(51) Int. Cl. G05D 23/13; F16K 31/00; F16K 31/60; F16K 31/53

(52) U.S. Cl. CPC G05D 23/1353; F16K 31/002; F16K 19/006; F16K 31/53; F16K 31/605

(57) ABSTRACT

A thermostatic mixer, including manually adjusting means to adjust the inflow rates of hot water and cold water in the mixer, operable by the user, and automatic adjusting means to adjust the temperature of the mixed water delivered by the mixer, adjustable by the user, is described. The user manually adjusts the flow rate and sets the desired temperature of the mixed water; the temperature is feedback controlled by automatic thermostat means. The mixer includes a single control lever operable by the user to control both the manually adjusting means to adjust the inflow rates of hot and cold water and the automatic adjusting means to adjust the temperature of the mixed water. In order to facilitate adjusting of the temperature, the mixer includes a gear mechanism functionally interposed between the control lever and the adjusting shaft of the automatic adjusting means to adjust the temperature of the mixed water.

### FIELD OF THE INVENTION

The present invention generally concerns the field of taps and fittings and particularly concerns a thermostatic mixer of hot and cold water for sanitary fixtures, provided with a single control lever to adjust the temperature and flow rate of the mixed water delivered to users.

### STATE OF THE ART

In the field of taps and fittings, cartridge mixers, which can be inserted in a tap body, provided with separate inlets for the hot water and the cold water and having means for intercepting such inlets, means for adjusting the flow rate of mixed water delivered to users, and means to vary the mixing ratios of the two types of water depending on the temperature of the mixed water to deliver through an outlet, have been known for a long time.

Generally, there are mixers provided with an automatic regulator to adjust the temperature of the mixed water, called thermostatic regulator, and mixers devoid of such component.

The opening and closing of the mixer itself, the adjusting of the flow rate of the mixed water delivered to the user, and the varying of the hot water to cold water mixing ratios are carried out manually by acting on a single control lever of the mixer in the mixers devoid of thermostatic regulator. In this circumstance, the temperature of the mixed water is not adjusted automatically, but the user must place the single control lever in the position corresponding to the desired temperature of the mixed water; usually, the user proceeds by attempts, by displacing the lever and manually controlling the temperature of the mixed water delivered after each displacement (of the lever), or proceeds according to experience, if he is used to use that mixer and already knows how it works. Typically, the rotations of the control lever in a vertical plane are used to adjust the flow rate of the mixed water delivered and the rotations of the control lever in a horizontal plane are used to adjust the temperature of the mixed water delivered.

In the mixers provided with thermostatic regulator, the varying of the mixing ratios of the hot water and cold water flow rates is operated automatically by adjusting means which provide to maintain the temperature of the mixed water delivered as constant as possible over time. These mixers are provided with two control levers: a first control lever is used to adjust the flow rate of the mixed water delivered to the users, and a second control lever, or ring nut, is used to set a configuration of the thermostatic regulator to obtain the desired temperature of the mixed water.

Commonly, the thermostatic regulator comprises, in different positions along its longitudinal axis, side holes for the separate inflow of hot and cold water. The regulator is inserted coaxially in the mixer body. Two annular chambers, through which sanitary cold water and hot water are separately supplied to the corresponding side holes of the thermostatic regulator, are defined between the thermostatic regulator and the mixer body. The mixing of the hot water with the cold water occurs in the thermostatic regulator, at an inner mixing chamber which opens outwardly, through an outlet hole usually provided at the bottom of the mixer body.

The thermostatic regulators comprise a heat-sensitive sensor, for example a wax sensor or a metal bulb, which, by expanding proportionally to the varying of the temperature of the water passing through the mixing chamber, controls the axial movement of a regulator for adjusting the flow rates of the hot water and cold water coming through the side holes of the thermostatic regulator itself, and consequently feedback adjusts the temperature of the mixed water coming out of the mixer. The flow rate regulator is usually a piston sliding axially in the mixing chamber: depending on the axial position of the piston, the side holes of the thermostatic regulator are more or less throttled.

For example, EP-A-0942347 describes a thermostatic expansion sensor, and WO 2015/104325 describes a thermostatic regulator.

Usually, the movement of the two control levers or ring nuts is only rotational on a single plane in the thermostatic mixers, and not on orthogonal planes as occurs in mixers devoid of thermostatic regulator. In particular, the first control lever for adjusting the flow rate rotates on a first plane, in both directions, and the second control lever, or ring nut, of the thermostatic regulator rotates in both directions on a second plane parallel to the first.

An example of a mixer provided with thermostatic regulator is described in WO 2018/142235 with reference to FIGS. 3-7: the first control lever (of the flow rate of the mixed water delivered to users) is denoted by the numerical reference 6 and the second control lever (of the thermostatic regulator) is denoted by the numerical reference 6′. The first control lever is connected to ceramic plates that are overlapping and provided with through holes: by acting on the first control lever, the holes of the plates are aligned, partially aligned or misaligned to adjust the outflow rate of the mixed water delivered. The second control lever is connected to the thermostatic regulator: by acting on the second control lever, the user adjusts the axial travel limit of the heat-sensitive bulb, and thus adjusts the position of the piston, which is connected to the bulb, that adjusts the mixing degree of the hot water and cold water.

The Applicant has found that many users are bothered by using two control levers because they are used to using mixers devoid of thermostatic regulator, i.e. they are used to using a single control lever.

US 2011/240155 describes a thermostatic mixer having the characteristics described in the preamble of claim 1. In particular, this document describes a thermostatic mixer comprising manually adjusting means to adjust the inflow rates of hot water and cold water in the mixer, operable by the user, and automatic adjusting means to adjust the temperature of the mixed water delivered by the mixer, adjustable by the user. The mixer comprises a single control lever operable by the user to control both the manually adjusting means to adjust the inflow rates of hot water and cold water and the automatic adjusting means to adjust the temperature of the mixed water, and not two distinct operable levers or ring nuts.

The Applicant has also found that the solutions with the single control lever can be improved. In particular, the Applicant has found that it can be difficult to adjust the temperature due to the limited travel that the control lever can have. In fact, considering that taps are usually placed closed to a wall, the rotation of the control lever on a horizontal plane cannot be greater than 180°, since there would not be space for greater rotations, and, generally, the rotations of the control lever of a mixer are anyhow equal to 100° at the most.

In other words, it is desirable that the thermostatic mixers with single control lever are also effective in adjusting the temperature when the rotation of the control lever on the horizontal plane is contained, equal to 100° at the most.

### SUMMARY OF THE INVENTION

Object of the present invention is to provide a mixer provided with thermostatic regulator, with single control lever, that is simple and easy to use and which allows to adjust the temperature of the water delivered in a precise way.

The present invention thus concerns the thermostatic mixer according to claim 1.

In particular, the thermostatic mixer comprises a body provided with a longitudinal axis, manually adjusting means to adjust the inflow rates of hot water and cold water in the mixer, which are operable by the user, and automatic adjusting means to adjust the temperature of the mixed water delivered by the mixer, adjustable by the user. The user thus manually adjusts the flow rate and sets the desired temperature of the mixed water; the temperature is feedback controlled by automatic means, a thermostat in fact.

The mixer comprises a single control lever operable by the user to control both the manually adjusting means to adjust the inflow rates of hot water and cold water and the automatic adjusting means to adjust the temperature of the mixed water, and not two distinct operable levers or ring nuts. In particular, the control lever is rotatable both on a vertical plane parallel to the longitudinal axis or containing such axis, to adjust the flow rate, and on a horizontal plane orthogonal to the longitudinal axis, to adjust the temperature. Since the adjusting means of the temperature of the mixed water are automatic, a possible variation of the flow rate set by the user by means of the control lever does not modify the temperature once the desired temperature has been set for the mixed water, since the adjusting means compensate the effective variation of the flow rates of cold water and hot water.

The user thus has the advantage of using the thermostatic mixer as if it were a completely manual conventional mixer notoriously provided with a single control lever, but having the automatic adjustment of the temperature of the mixed water available, typical of the thermostatic mixers provided with two operating levers or ring nuts.

Advantageously, the mixer comprises a gear mechanism functionally interposed between the single control lever and the automatic means to adjust the temperature of the mixed water. The function of the gear mechanism is to transmit the settings imparted by the user to the automatic adjusting means of the temperature of the mixed water by means of the control lever, according to a gear ratio different from 1:1, and in particular greater than 1:1, so that the rotations imparted by the control lever are transmitted amplified to the automatic adjusting means of the temperature of the mixed water.

This detail allows to obtain the maximum sensitivity when adjusting the temperature of the mixed water, for the same rotations imparted to the control lever, with respect to conventional solutions. In fact, the gear mechanism amplifies the rotations transmitted to the automatic adjusting means of the temperature of the mixed water and this allows to obtain a wide range of temperature adjustments.

The solution suggested clearly overcomes the limits of the currently available solutions: also if the rotations of the control lever on a horizontal plane are limited by the presence of a wall, or two walls, the gear ratio provided to operate the automatic adjusting means of the temperature of the mixed water allows to obtain the desired temperature anyway, also if the control lever can rotate by a small angle, even of less than 100°. In practice, this advantage translates into the possibility to install the mixer in little spaces, or anyhow into the possibility to obtain the maximum sensitivity when adjusting the temperature of the mixed water.

In the preferred embodiment, the mixer body is internally provided with a water mixing chamber, and side openings provided at different heights of the body with respect to the longitudinal axis, for the separate supply of hot water and cold water in said mixing chamber. The flow rates adjusting means comprise at least two overlapping plates, for example ceramic plates, equipped with canalizations directed to the side openings of the mixing chamber; the canalizations can be opened and closed depending on the mutual position assumed by the two plates with respect to the longitudinal axis, i.e. the plates work as a tap to allow or prevent the passage of hot water and cold water towards the mixing chamber, with maximum or modulated flow rates. The automatic adjusting means to adjust the temperature comprise a thermostat active in the mixing chamber and an element for intercepting the flow rates of hot water and cold water, movable along the longitudinal axis to completely or partially, and selectively, feedback close the supplying side openings depending on the expansions suffered by the thermostat. The gear mechanism transmits the rotations (adjustments) imparted by the user on the single control lever to the automatic adjusting means of the temperature, but in an amplified way, for example according to a gear ratio 1:2.

For example, the thermostat comprises a telescopic shaft extending cantileverly in the mixing chamber, along the longitudinal axis, and moving in response to the expansions of the thermostat caused by the water in the mixing chamber. A piston is connected to the thermostat and has the function of feedback adjusting the inflows of hot water and cold water in the mixing chamber, depending on the configuration assumed by the thermostat from time to time. Means for limiting the travel of the telescopic shaft itself and thus to control the volume of the mixing chamber are combined with the telescopic shaft. In this embodiment, the gear mechanism is functionally interposed between the single control lever and the means for limiting the travel of the telescopic shaft.

Further characteristics of the thermostatic mixer are described in the dependent claims.

### BRIEF LIST OF THE FIGURES

Further characteristics and advantages of the invention will be better highlighted by the review of the following detailed description of a preferred, but not exclusive, embodiment illustrated by way of example and without limitations, with the aid of the accompanying drawings, in which:

FIG. 1 is a sectional longitudinal view of a thermostatic mixer according to the present invention;

FIG. 2 is a schematic perspective view from above of a component of the thermostatic mixer shown in FIG. 1;

FIG. 3 is a schematic perspective view from the bottom of a component of the thermostatic mixer shown in FIG. 1;

FIG. 4 is a perspective and exploded view of the thermostatic mixer shown in FIG. 1;

FIG. 5 is a perspective and exploded view of some components of the thermostatic mixer shown in FIG. 1;

FIG. 5A is a perspective and partial sectional view of some of the components of the thermostatic mixer shown in FIG. 1;

FIG. 6 is a sectional and schematic longitudinal view of the thermostatic mixer shown in FIG. 1, with the movements of some components denoted;

FIGS. 7-9 are plan views of corresponding components of the thermostatic mixer shown in FIG. 1;

FIGS. 10-13 are schematic plan views of corresponding configurations of the components shown in FIGS. 7-9;

FIG. 14 is a cross-sectional view of the thermostatic mixer shown in FIG. 1;

FIGS. 15-17 are sectional longitudinal views of the thermostatic mixer shown in FIG. 1, in corresponding configurations of use;

FIGS. 18-20 are perspective and partial sectional views of the thermostatic mixer shown in FIG. 1, in corresponding configurations of use;

FIG. 21 is a schematic plan view of the mixer shown in FIG. 1, in a first configuration defined “energy saving”;

FIG. 22 is a schematic plan view of the mixer shown in FIG. 1, in a second configuration;

FIG. 23 is an elevation view of the mixer shown in FIG. 1 and of an adapting element for the coupling to a tap body;

FIG. 24 is a perspective view from above of the adapting element shown in FIG. 23;

FIG. 25 is a partial sectional longitudinal view of the thermostatic mixer shown in FIG. 1 and of a first accessory thereof, a flow diverter;

FIG. 26 is a schematic plan view of components of the first accessory of the thermostatic mixer shown in FIG. 1;

FIG. 27 is a cross-sectional view A-A from the bottom of the thermostatic mixer shown in FIG. 25;

FIG. 28 is sectional longitudinal view of the thermostatic mixer shown in FIG. 1 and of a second accessory thereof, a pressure balancer;

FIGS. 29-31 are partial sectional longitudinal views of a second embodiment of the mixer according to the invention;

FIG. 32 is a plan view from above of the second embodiment shown in FIGS. 29-31.

### DETAILED DESCRIPTION OF THE INVENTION

In the accompanying figures, the same reference numbers are used to identify elements that are equal or equivalent to each other.

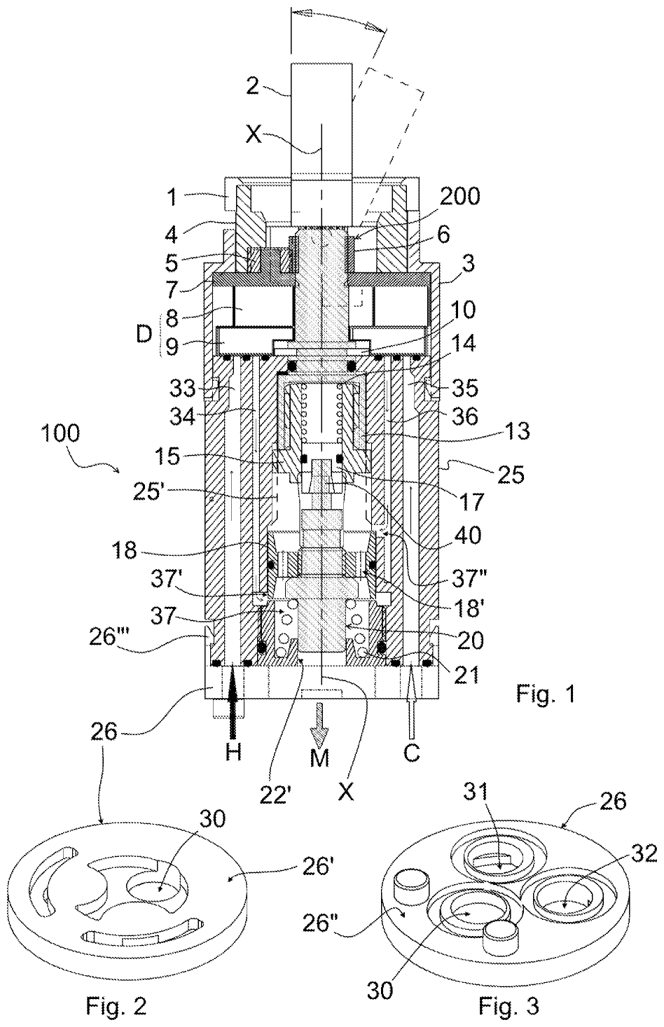

FIG. 1 shows a thermostatic mixer 100 according to the present invention, in the longitudinal section, i.e. in section on a plane containing the longitudinal axis X-X.

For simplicity, the thermostatic mixer 100 will hereinafter be named mixer 100. The mixer 100 can be inserted in a tap of a sink, handbasin or bidet, or in a tap of a shower, or can also be built into the wall.

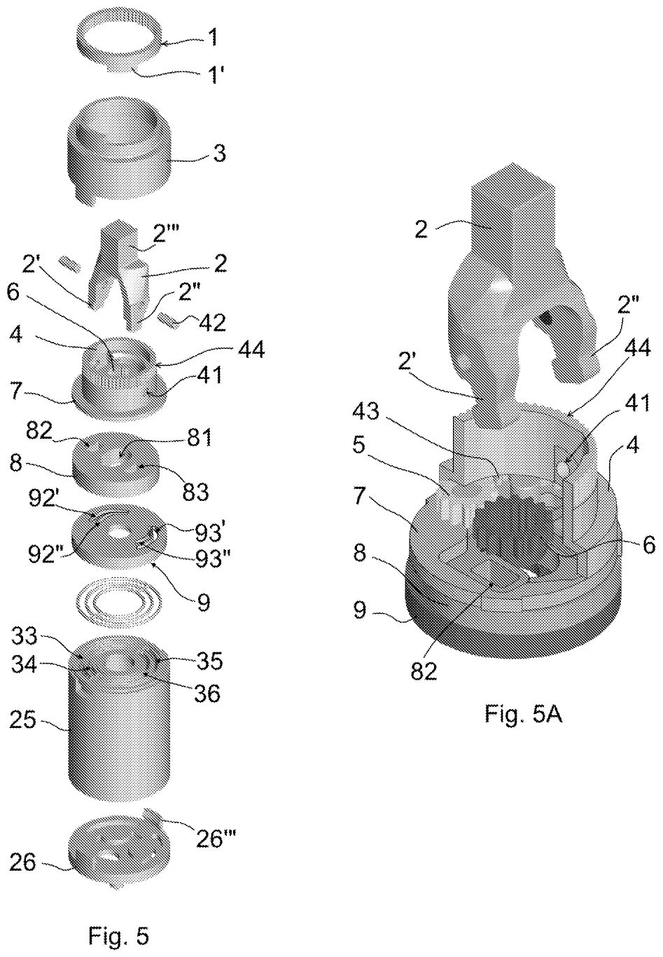

The mixer 100 comprises a cylindrical body 25 delimited on the bottom by a base 26 schematically shown in FIGS. 2 and 3, to which the supply ducts of the hot water and the cold water can be constrained. In particular, the reference 26′ denotes the upper face of the base 26 and the reference 26″ denotes the lower face of the base 26. As shown in FIG. 1, the base 26 is fixed to the body 25 of the mixer 100 with a snap-fit shape coupling obtained by the fins 26′″ which engage a corresponding annular seat present on the outer surface of the body 25. The fins 26′″ are not shown for simplicity in FIGS. 2 and 3, but are visible in FIG. 5.

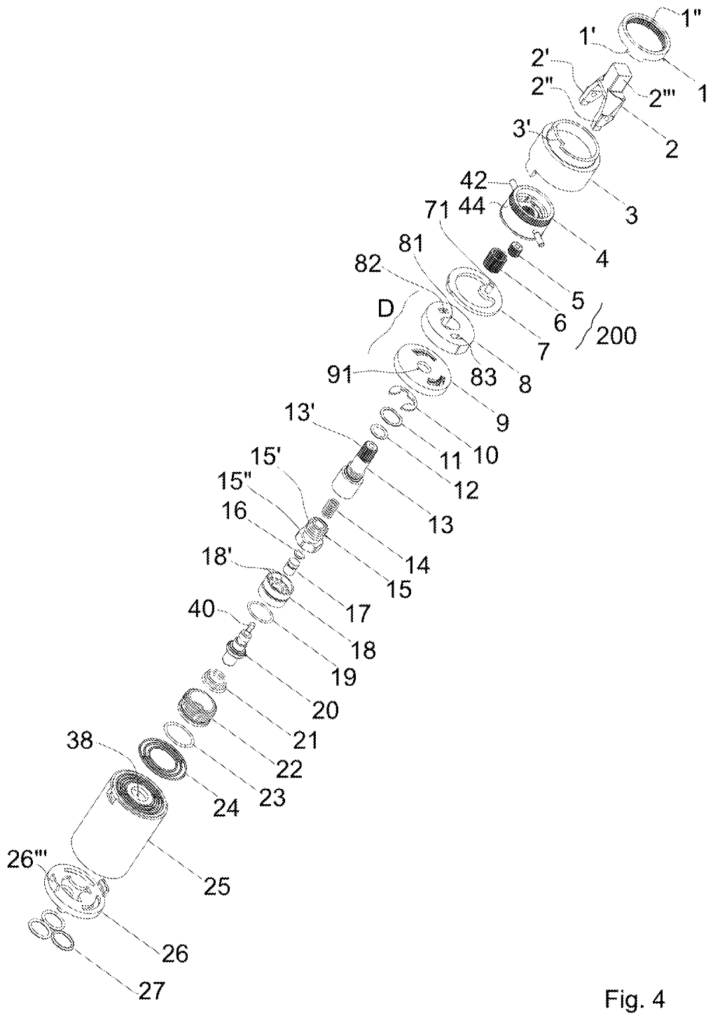

The base 26 comprises three through holes: a first hole 31 for the supply of hot water H, a second hole 32 for the supply of cold water C and a third hole 30 for the outflow of the mixed water M. The corresponding O-ring gaskets are shown in FIG. 4 with the reference 27.

There are passages 33 and 34 for the hot water H, passages 35 and 36 for the cold water C, in the body 25 of the mixer 100; the arrows in FIG. 1 show the paths of the two water flows. The flows of hot water H and cold water C are intercepted by an assembly of ceramic plates 8-9 generally denoted by the letter D. In other words, the passages 33 and 34 for the hot water H are separated from the assembly D of plates 8-9 and also the passages 35 and 36 for the cold water C are separated from the assembly D of plates 8-9. As will be described below, the plates 8-9 are perforated and, depending on the relative angular position they assume in response to the adjustments imparted by the user, completely or partially intercept the passage of water, i.e. prevent water from reaching the passage 34 and/or the passage 36, or allow the passage of modulated flow rates.

Thus, when the mixer is operated by the user, the two flows of hot water H and cold water C respectively enter the passages 33 and 35 through the holes 31 and 32 of the base 26. At this point, the two flows are adjusted by the assembly D of plates 8-9 and proceed modulated in the passages 34 and 36 to reach a mixing chamber 37 inside the body 25. In particular, the hot water H enters the mixing chamber 37 through the annular opening 37′ and the cold water C enters the mixing chamber 37 through the opening 37″.

As can be noted by looking at FIG. 1, the openings 37′ and 37″ are longitudinally cantilevered, i.e. are at different heights: in the example shown in the figures, the opening 37′ is closer to the base 26 with respect to the opening 37″.

A thermostat 20, for example a liquid expansion bulb (wax) or with mechanical slats, is housed in the mixing chamber 37. The thermostat is partially inserted in a hole 22′ obtained in a bushing 22 screwed at the bottom of the body 25 of the mixer 100 and in turn closed by the base 26. The thermostat 20 is provided with a telescopic shaft 40 that recesses into the thermostat 20 or that extends therefrom depending on the thermal expansion suffered by the liquid or slats of the thermostat 20. Thus, the thermostat 20 is susceptible to small displacements in the hole 22′, without being able to slip out therefrom, and the telescopic shaft 40 is susceptible to longitudinal translations, on the axis X-X, with respect to the rest of the thermostat 20.

A piston 18, having the function to adjust the inflows of hot water H and cold water C in the mixing chamber 37, is mounted on the thermostat 20 in order to adjust the temperature of the mixed water M delivered to the user. The temperature variations caused in the thermostat 20 by the hot water H have the effect of causing the expansion thereof; by expanding, the thermostat 20 feedback controls the movements of the piston 18. By moving axially, i.e. along the axis X-X, the piston 18 completely or partially, and selectively, intercepts the openings 37′ and 37″ to correspondingly adjust the flow rates of hot water H and cold water C directed towards the mixing chamber 37.

The longitudinal movements of the thermostat piston 20 and of the piston 18 are hindered by two opposite elastic elements: a first spring 14 positioned above and which constantly exerts a downward thrust on the telescopic shaft 40 of the thermostat 20, i.e. towards the base 26, and a second spring 21 positioned under the thermostat 20 and having the function of constantly exerting an upward thrust on the thermostat 20, i.e. towards the assembly D of plates 8-9.

With particular reference to FIGS. 1 and 4, the piston 18 is a substantially toroidal element which comprises a central portion, in which there is a hole slidingly fitted on the thermostat 20, and a peripheral portion intended to laterally abut against the inner surface of the mixing chamber 37. Several water-crossing channels 18′ are defined between the central portion and the peripheral portion. The channels 18′ are distributed with a regular and circumferential pitch around the central portion.

With particular reference to the FIGS. 1 and 4-6, the telescopic shaft 40 of the thermostat 20 is inserted in a restraining element 17, which is a bushing in the example shown. The bushing 17 has a blind hole in which the telescopic shaft 40 is inserted, and the two elements 17 and 40 abut against each other. There is an O-ring gasket 16 on the outer surface of the bushing 17. The bushing 17 is slidingly inserted inside a screw element 15; the gasket 16 prevents the passage of water above the bushing 17. The screw element 15 is hollow, in the sense that it has a longitudinal through hole, at the axis X-X, and the bushing 17 is sliding in such hole, right along the X-X axis. The first spring 14 is positioned right above the bushing 17 to hinder the upward displacements with respect to the screw element 15.

In turn, the screw element 15 has an outer threading 15′ that engages a corresponding inner threading of a control rod 13 inserted in the upper hole 38 of the body 25 of the mixer 100 and extending through the assembly D of the plates 8-9. The threaded part of the screw element 15 is housed in the control rod 13 and the latter is rotatably installed on the body 25 of the mixer 100 and stopped by a Seeger ring 10. The control rod 13 can rotate on the longitudinal axis X-X, but is not susceptible to longitudinal displacements with respect to the body 25 of the mixer 100.

As can be noted in FIG. 4, the screw element 15 has a polygonal portion 15″, in particular hexagonal, which abuts against the inner surface 25′ of the body 25 joined thereto (of complementary shape). Such polygonal portion 15″ defines the upper border of the mixing chamber 37 and the bushing 22′ defines the lower border.

Together, the coupling (by screwing) of the screw element 15 with the control rod 13 and the shape-coupling of the screw element 15 with the body 25 of the mixer 100 define degrees of freedom of the screw element 15 itself, which can be lowered in the body 25, i.e. can be displaced longitudinally towards the base 26, or the screw element 15 can be raised, i.e. displaced longitudinally in an opposite direction, towards the assembly D of plates 8-9.

In fact, as will be described below, the clockwise (counterclockwise) rotation of the control rod 13 on the longitudinal axis X-X imparted by the user causes the unscrewing of the screw element 15 of the control rod 13 itself, since the screw element cannot rotate on the axis X-X due to the shape-coupling with the body 25 of the mixer 100, and thus causes the translation towards the base 26 of the screw element 15 itself and of the bushing 17 constrained thereto; in turn, the bushing 17 pushes the telescopic shaft 40 and causes its partial insertion in the thermostat 20. This reduces the volume of the mixing chamber 37 and provides less travel for the telescopic shaft 40 of the thermostat 20, which, now being mostly inserted in the thermostat 20, can extend of a reduced travel, thus hindering the first spring 14. By observing the FIGS. 15-17 in order, it is possible to observe the exact sequence just described.

Vice-versa, the counterclockwise (clockwise) rotation of the control rod 13 on the longitudinal axis X-X causes the screwing of the screw element 15 in the control rod 13 itself, since the screw element cannot rotate on the axis X-X for the reason explained above, and thus causes the translation towards the plates 8-9 of the screw element 15 itself and of the bushing 17 constrained thereto; the telescopic shaft 40 extends from the thermostat 20 since the spring 14 exerts a lesser thrust with respect to the preceding case (because it is further away from the thermostat 20). This increases the volume of the mixing chamber 37 and provides more travel for the telescopic shaft 40 of the thermostat 20, which will be subjected to more displacements in response to the increase in temperature. By observing the FIGS. 17-15 in order, it is possible to observe the exact sequence just described.

In other words, the position of the screw element 15 along the longitudinal axis X-X defines the position of the telescopic shaft 40 of the thermostat 20 and the preload of the first spring 14. Thus, positioning the screw element 15 along the longitudinal axis X-X, at a certain height, corresponds to determining the longitudinal position of the telescopic shaft 40: the springs 14 and 21 are counteracting and thus influence the repositioning of the piston 18 together. Thus, adjusting the position of the screw element 15 means adjusting the inflow rates of hot water H and cold water C in the mixing chamber 37 and consequently adjusting the temperature of the mixed water M delivered to the user through the third hole 30 of the base 26.

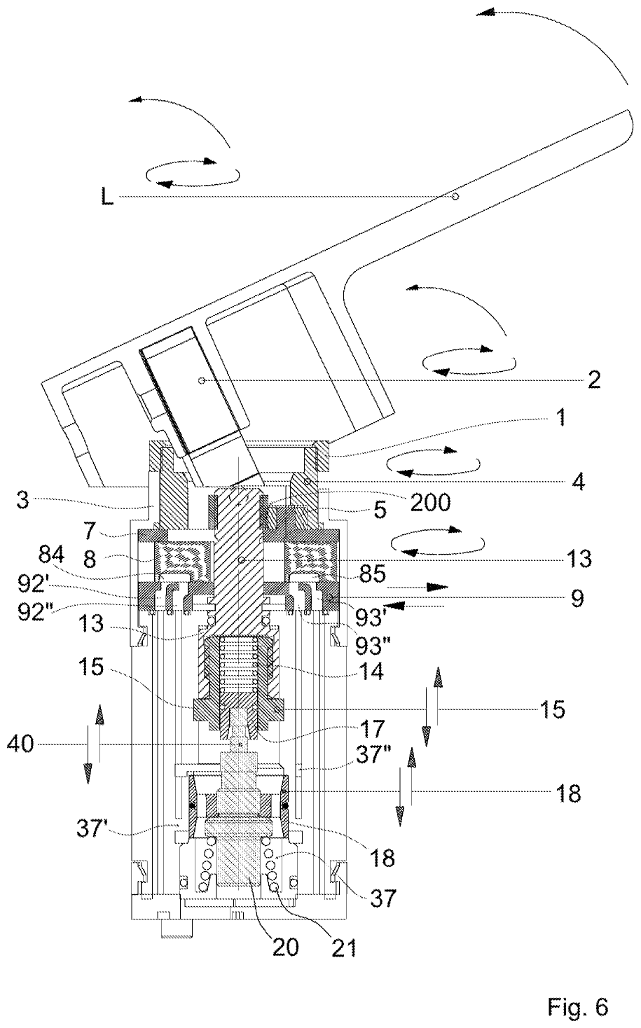

The arrows in FIG. 6 schematically denote the movements that the screw element 15 (together with the bushing 17), the telescopic shaft 40 of the thermostat 20 and the piston 18 can perform: these are longitudinal movements in two directions.

With reference to the FIGS. 1 and 4-17, the control rod 13 goes through the plates 8-9. In FIG. 4, it is possible to note that the lower plate 9 is equipped with a central and circular through hole 91 and the upper plate 8 is instead provided with a through slot 81. Thus, the control rod 13 fits in the hole 91 without clearance and goes through the slot 81 with clearance. On the upper ends of the control rod 13, opposite the screw element 15, there are longitudinal grooves 13′ and a gear mechanism 200 is mounted, comprising a first gear 6 equipped with inner grooves complementary to the grooves 13′. Thus, the rotations imparted to the first gear 6 are directly transmitted to the control rod 13. The first gear 6 is held coupled with a corresponding second gear 5 of the gear mechanism 200, defined multiplying gear, mounted on a washer 7 provided with a specific pin 71. In turn, the multiplying gear 5 is functionally coupled with a connection 4 of the gear mechanism 200 holding the plates 8-9 and the washer 7 stacked on the body 25 of the mixer. A lid or spherical cap 3 is snap-fit constrained to the body 25 of the mixer 100 in order to retain the elements 4-9 and 13 in the positions described.

With particular reference to FIGS. 4-5A, the connection 4 is a substantially cylindrical element provided with:
radial holes 41 intended to receive pins 42 for coupling with a fork-shaped control lever 2, so that to allow the rotation on an axis orthogonal to the longitudinal axis X-X;
inner toothing (rack) 43 for the functional coupling with the multiplying gear 5;
longitudinal grooves 44 at the outer side surface and at the upper edge, in order to allow the connection of a ring 1 equipped with travel limit surfaces 1′ for limiting the temperature and with corresponding inner longitudinal grooves 1″.

The fork-shaped control lever 2, henceforth simply fork, has a central stem 2′″ and two parallel legs 2′ and 2″ extending from the central stem 2″. The central stem 2′″ is intended to be fixed to the handle L operable by the user, while the legs 2′ and 2″ are intended to be inserted through the connection 4 of the gear mechanism 200 and through the washer 7, to fit into the corresponding holes 82 and 83 of the upper plate 8. The legs 2′ and 2″ are pivoted on the connection 4 by means of the pins 42; in practice, the connection 4 and the fork 2 form a joint.

The rotations imparted by the user to the handle L are transmitted directly to the fork 2, both those on a horizontal plane and those on a vertical plane, as schematically depicted in FIG. 6.

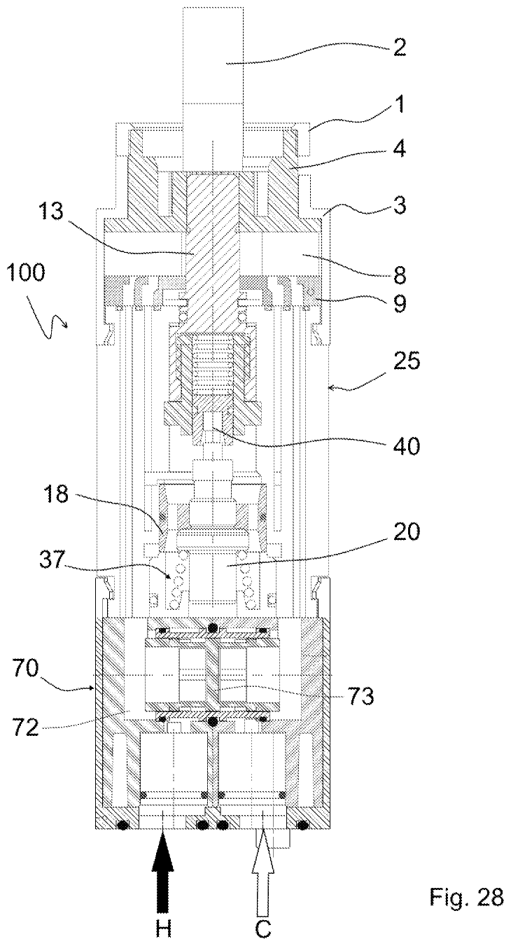

The rotations of the handle L and of the fork 2 on a horizontal plane do not have an effect on the washer 7, which remains stationary, but are transmitted to the upper plate 8 due to the fact that the legs 2′ and 2″ are inserted in the holes 82 and 83. Since the lower plate 9 also remains stationary, the rotations imparted on a horizontal plate to the handle L translate into rotations of the upper plate 8 with respect to the lower plate 9. As shown in FIGS. 6 and 28, there are grooves 84 and 85 on the lower face of the upper plate 8, each extending along an arch of circumference and which, depending on the angular position assumed by the upper plate 8 with respect to the lower plate 9, put in fluidic communication the passage 33 with the passage 34 and the passage 35 with the passage 36, either partially, i.e. with modulated flow rates, or completely, with maximum flow rates.

The rotations of the handle L and of the forks 2 on a horizontal plane are also transmitted to the connection 4 of the gear mechanism 200, since this element is constrained to the fork 2 by means of the radial pins 42. By observing FIG. 5A, it can be noted that the connection 4 comprises inner toothing 43 (rack), extending circumferentially on the inner surface of the connection, in proximity of the lower edge. Such toothing (rack) 43 engages the multiplying gear 5 mounted on the washer 7; in turn, the multiplying gear 5 engages the first gear 6. Thus, the rotations imparted by the user to the L on a horizontal plane are transmitted to the connection 4, to the multiplying gear 5, to the first gear 6 depending on the gear ratio defined by the gear mechanism 200 itself with the multiplying gear 5, and finally to the control rod 13. As described above, the rotations of the control rod 13 determine the displacement of the bushing 17 and, thus, the travel of the shaft 40 of the thermostat 20.

Thus, in a nutshell, the rotations of the handle L on a horizontal plane allow to adjust the thermostat 20, i.e. to set the temperature of the mixed water M delivered to the user.

The numerical references 11-12, 16, 23-24 and 27 denote gaskets.

With reference to FIGS. 4-6 and especially with reference to FIG. 5A, the rotations imparted by the user to the handle L on a vertical plane cause a corresponding displacement of the upper plate 8 on a horizontal plane. This because the fork 2 is pivoted on the connection 4 by means of the radial pins 42 and the rotations of the handle L on a vertical plane cause the fork 2 to rotate right on such pins 42; the legs 2′ and 2″ exert a thrust on the inner walls of the corresponding holes 82 and 83 in a direction orthogonal to the axis X-X, i.e. a horizontal thrust. By raising the handle L (and thus the fork 2), the user aligns the upper plate 8 with respect to the lower plate 9 and the user misaligns the upper plate 8 with respect to the lower plate 9 by bringing back the handle L (and thus the fork 2) to the initial position. The alignment of the plates 8 and 9 involves putting the passages 33-34 and 35-36 in fluidic communication by means of the canalizations 84 and 85 of the upper plate 8, while misaligning the plates 8 and 9 involves completely closing the passages 33-34 and 35-36 by misaligning the canalizations 84 and 85 present on the lower surface of the upper plate 8 with respect to the passages 33-34 and to the passages 35-36. Clearly, the maximum upward rotation of the handle L (and of the fork 2) corresponds to the maximum flow rate of mixed water M delivered to the user; the alignment of the plates 8 and 9 is the maximum possible and the passages 33-34 and the passages 35-36 are in fluidic communication with the maximum flow rate. An incomplete upward rotation of the handle L (and of the fork 2), in an intermediate position with respect to the horizontal handle L and completely raised handle L, corresponds to a modulated flow rate of mixed water M delivered to the user: the alignment of the plates 8 and 9 is partial and the passages 33-34 and the passages 35-36 are in fluidic communication with a modulated flow rate.

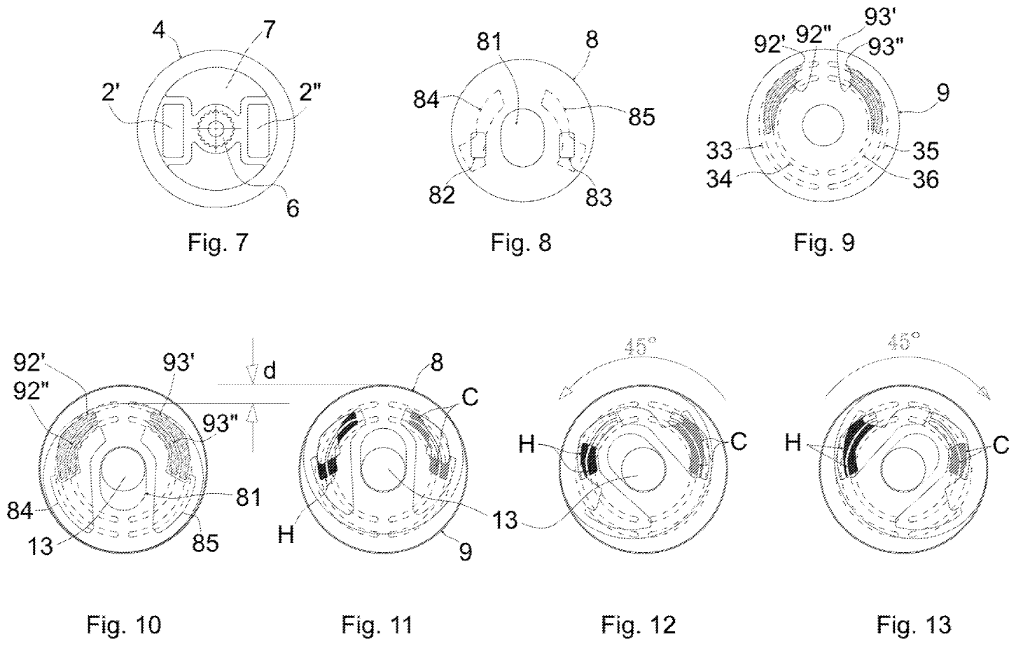

FIG. 7 shows a schematic plan view from above of the connection 4, the washer 7, the first gear 6, the legs 2′ and 2″ the fork 2 and of the corresponding seats 82 and 83 obtained in the upper plate 8.

FIG. 8 is a schematic plan view of the upper plate 8. The continuous line shows the seats 82 and 83 of the legs 2′ and 2″ of the fork 2, and the dotted line schematically shows the canalizations 84 and 85 (also visible in FIG. 6) that overlap the canalizations 92′, 92″, 93′ and 93″ of the lower plate 9, which are shown with dotted lines.

FIG. 9 is a schematic plan view of the lower plate 9. The continuous line shows the respective canalizations 92′, 92″, 93′ and 93″ (also visible in FIG. 6) that overlap the passages 33-34 and the passages 35-36 of the body 25 of the mixer 100, which passages are shown with dotted lines.

FIG. 10 shows a first configuration of the mixer 100; in particular, it shows the mixer 100 in the completely closed position: no mixed water flow rate is delivered. The ceramic plates 8 and 9 are overlapping with a mutual position that does not provide for the overlapping of the canalizations 84 and 85 of the upper plate 8 on the canalizations 92′-92″ and 93′-93″ of the lower plate 9.

FIG. 11 shows a second “mixed open” configuration of the mixer 100; in particular, it shows the mixer 100 in the open position with a maximum flow rate of mixed water M, and equal inflow rates of cold water C and hot water H in the mixing chamber 37. In this example, the position of the handle L is at the center (symmetry). With respect to the closed position shown in FIG. 10, the upper plate 8 was radially translated of a length d by the fork 2: the control rod 13 abuts against the end opposite the slot 81. The ceramic plates 8 and 9 are overlapping with a mutual position that provides for the partial overlapping of the canalizations 84 and 85 of the upper plate 8 on the canalizations 92′-92″ and 93′-93″ of the lower plate 9. In particular, the letters H and C respectively denote the flow rates of hot water and cold water channeled to the mixing chamber 37; the areas made available to the two flow rates H and C are equal and correspond to 16 mm².

FIG. 12 shows a third “cold open” configuration of the mixer 100; in particular, it shows the mixer 100 in the open position with a maximum flow rate of mixed water M (handle L completely raised), and different inflow rates of cold water C and hot water H in the mixing chamber 37. In this example, the position of the handle L is rotated by 45° to the right with respect to the center, i.e. counterclockwise. With respect to the open position with equal H and C flow rates, shown in FIG. 11, the upper plate 8 was rotated counterclockwise by the fork 2. The ceramic plates 8 and 9 are overlapping with a mutual position that provides for the partial overlapping of the canalizations 84 and 85 of the upper plate 8 on the canalizations 92′-92″ and 93′-93″ of the lower plate 9. In particular, the letters H and C respectively denote the flow rates of hot water and cold water channeled to the mixing chamber 37; the areas made available to the two flow rates are different and correspond to 12.6 mm² for the hot water and 23.8 mm² for the cold water. The mixed water M will thus have a lower temperature with respect to the configuration shown in FIG. 11.

FIG. 13 shows a fourth “hot open” configuration of the mixer 100; in particular, it shows the mixer 100 in the open position with a maximum flow rate of mixed water M (handle L completely raised), and different inflow rates of cold water C and hot water H in the mixing chamber 37. In this example, the position of the handle L is rotated by 45° to the left with respect to the center, i.e. clockwise. With respect to the open position with equal H and C flow rates, in FIG. 11, the upper plate 8 was rotated clockwise by the fork 2. The ceramic plates 8 and 9 are overlapping with a mutual position that provides for the partial overlapping of the canalizations 84 and 85 of the upper plate 8 on the canalizations 92′-92″ and 93′-93″ of the lower plate 9. In particular, the letters H and C respectively denote flow rates of hot water and cold water channeled to the mixing chamber 37; the areas made available to the two flow rates are different and correspond to 23.8 mm² for the hot water and 12.6 mm² for the cold water. The mixed water M will thus have a higher temperature with respect to the configuration shown in FIG. 11.

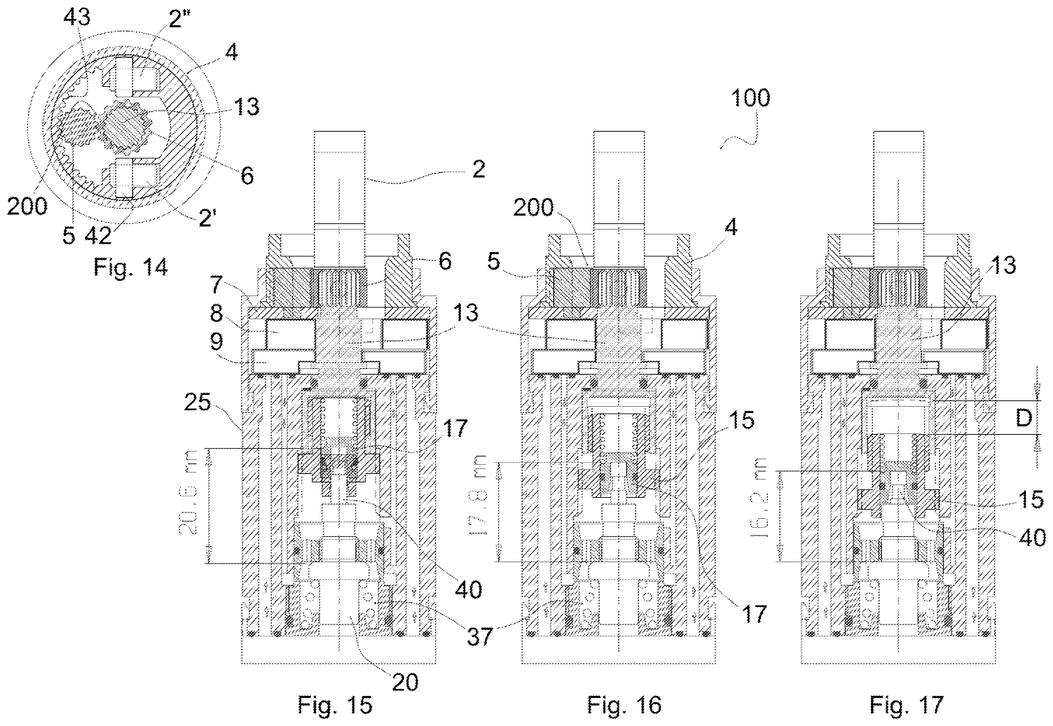

FIG. 14 is a cross-sectional view, on a plane orthogonal to the axis X-X that intercepts the gears 4-6 of the gear mechanism 200. In this figure, the arrangement of the gears 4-6, the toothing (rack) 43 inside the connection 4, the control rod 13 and the legs 2′ and 2″ of the fork 2 are clearly visible.

Preferably, the gear ratio defined by the gear mechanism 200 by the gears 4-6 is equal to 1:2, i.e. the multiplying gear 5 has half the teeth of the gear 6. This means that the rotations imparted to the handle L on the horizontal plane are transmitted to the control rod 13 with double angles.

FIGS. 15-17 are sectional longitudinal views of the mixer 100, i.e. on a plane containing the axis X-X, in three corresponding configurations that are different for the position assumed, from time to time, by the screw element 15 bearing the bushing 17 in which the telescopic shaft 40 of the thermostat 20 is engaged.

The distance between the body of the thermostat 20 and the bottom of the blind hole of the bushing 17, indicative measure of the travel available to the telescopic shaft 40, is equal to 20.6 mm (maximum travel) in FIG. 15. This configuration corresponds to the one shown in FIG. 13.

The distance between the body of the thermostat 20 and the bottom of the blind hole of the bushing 17 is equal to 17.8 mm in FIG. 16, and the mixed water M is delivered at the temperature of 38° C. This configuration corresponds to the one shown in FIG. 11.

The distance between the body of the thermostat 20 and the bottom of the blind hole of the bushing 17 is equal to 16.2 mm (minimum travel) in FIG. 17. This configuration corresponds to the one shown in FIG. 12.

As can be noted, when the travel available to the telescopic shaft 40 is reduced, the interstice D (FIG. 17) that is formed between the screw element 15 and the bottom of the respective seat in the control rod 13 increases.

It is thus clear that the rotation of the handle L and of the fork-shaped element 2 integral therewith allows to adjust the thermostat 20, i.e. allows to set the temperature of the mixed water M, while the vertical rotation allows to adjust the flow rate of the mixed water M.

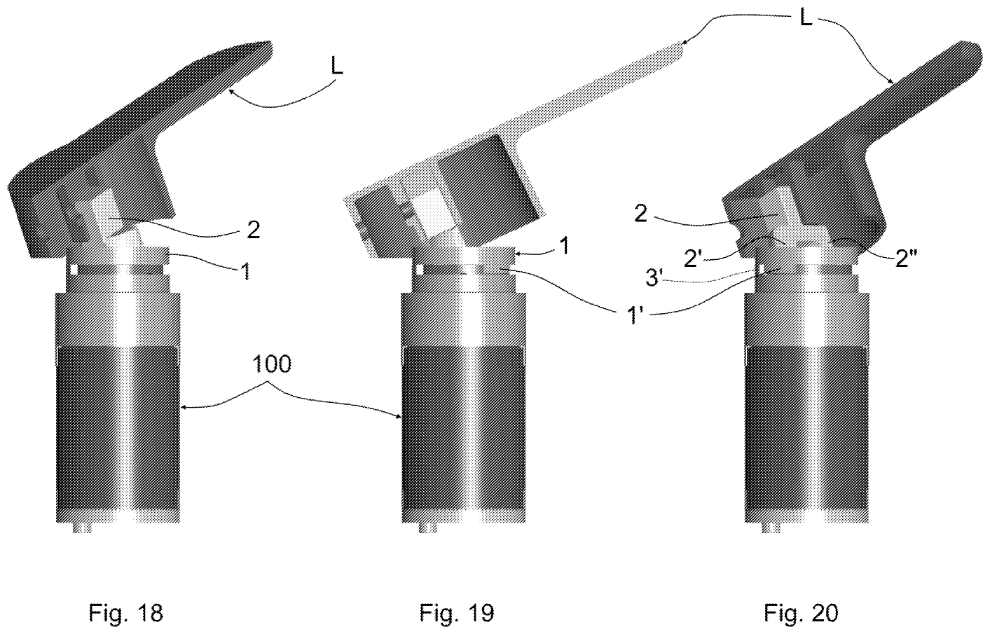

FIGS. 18-20 are perspective and partial sectional views of the mixer 100 complete with the handle L. In particular:
FIG. 18 shows the mixer 100 in the configuration also shown in FIGS. 12 and 17;
FIG. 19 shows the mixer 100 in the configuration also shown in FIGS. 11 and 16;
FIG. 20 shows the mixer 100 in the configuration also shown in FIGS. 13 and 15.

The ring 1 that can be repositioned on the connection 4 and equipped with travel limit surfaces 1′ is well visible in FIGS. 18-20. Such surfaces 1′ cooperate with the lid 3, and in particular with the corresponding protrusion 3′ (FIG. 4) to prevent the fork 2 and the handle L from rotating beyond a certain limit.

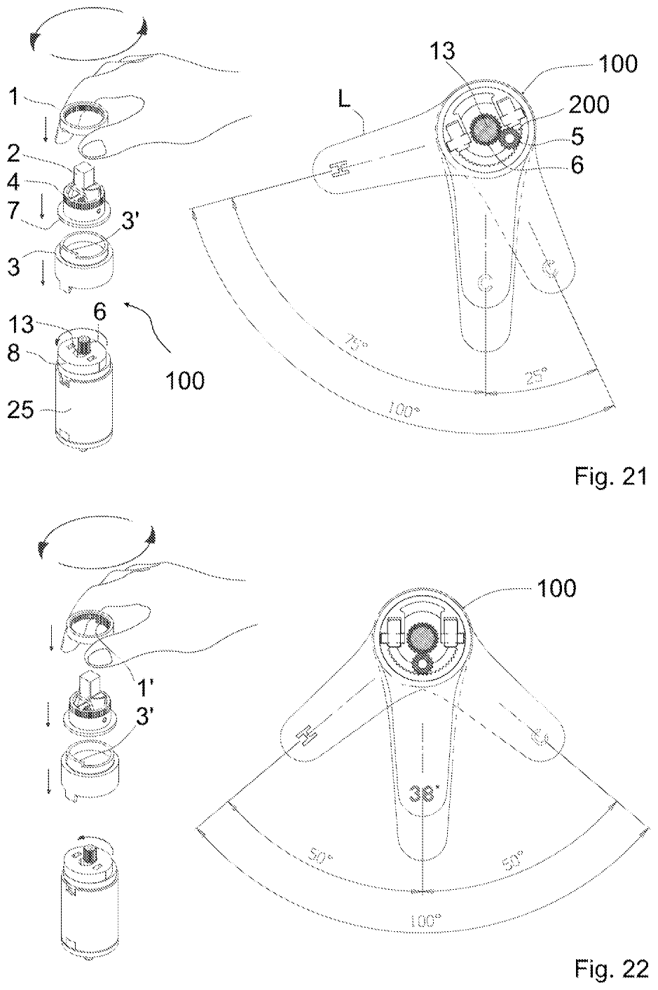

FIGS. 21 and 22 are schematic views of two implementation examples of the mixer 100.

FIG. 21 is shown in a configuration that can be defined “energy saving”, wherein the lever L is globally rotatable on the horizontal plane by 100°, but 75° are dedicated to the clockwise rotation in order to achieve the increase in temperature of the mixed water M delivered, and 25° are dedicated to the counterclockwise rotation in order to achieve the decrease in temperature of the mixed water M delivered. The intermediate position between the two angles of 75° and 25° corresponds to the configuration shown in FIGS. 12 and 17. As depicted in the figure, the energy saving configuration can be achieved by assembling the mixer by fitting the ring 1 on the connection 4 so that the travel limit 1′ and the surface 3′ are initially close.

The energy saving configuration is used to save thermal energy: the initial position of the handle L corresponds to the delivery of cold water and the user will provide to rotate the handle L clockwise if he wants warmer water, but no hot water is wasted.

FIG. 22 shows a conventional configuration with a handle L in the initial position corresponding to the configuration shown in FIGS. 11 and 16. In the initial position with the handle L in the center, the mixed water is delivered at the temperature of 38° C. The handle L can rotate clockwise and counterclockwise by equal extent: 50°. In this configuration, the ring 1 is fitted on the connection 4 so that the travel limit 1′ and the matching surface 3′ are initially diametrically opposed.

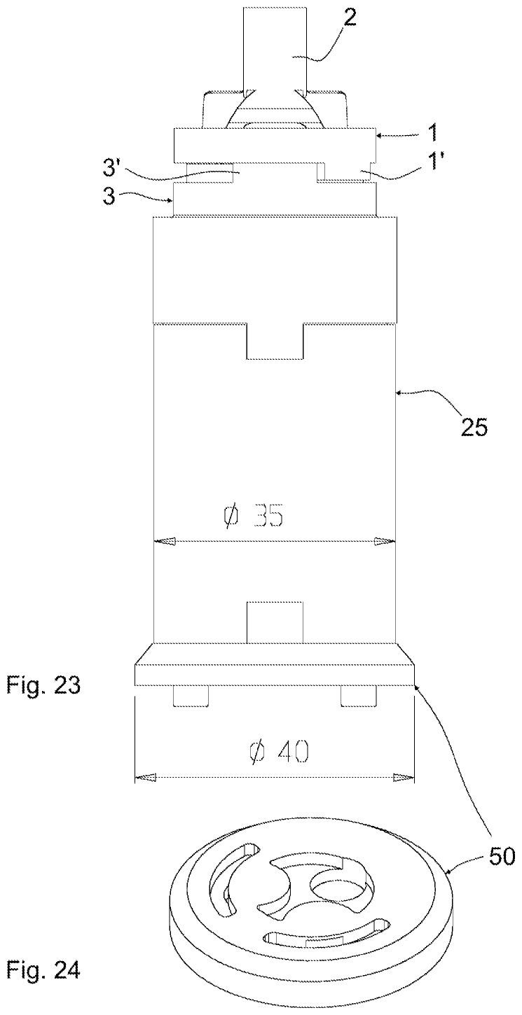

FIGS. 23 and 24 show the mixer 100 in an embodiment wherein the body 25 has an outer diameter of 35 mm, and the base 50 also works as an adapter to allow the installation of the mixer 100 also in taps with an inner diameter of 40 mm.

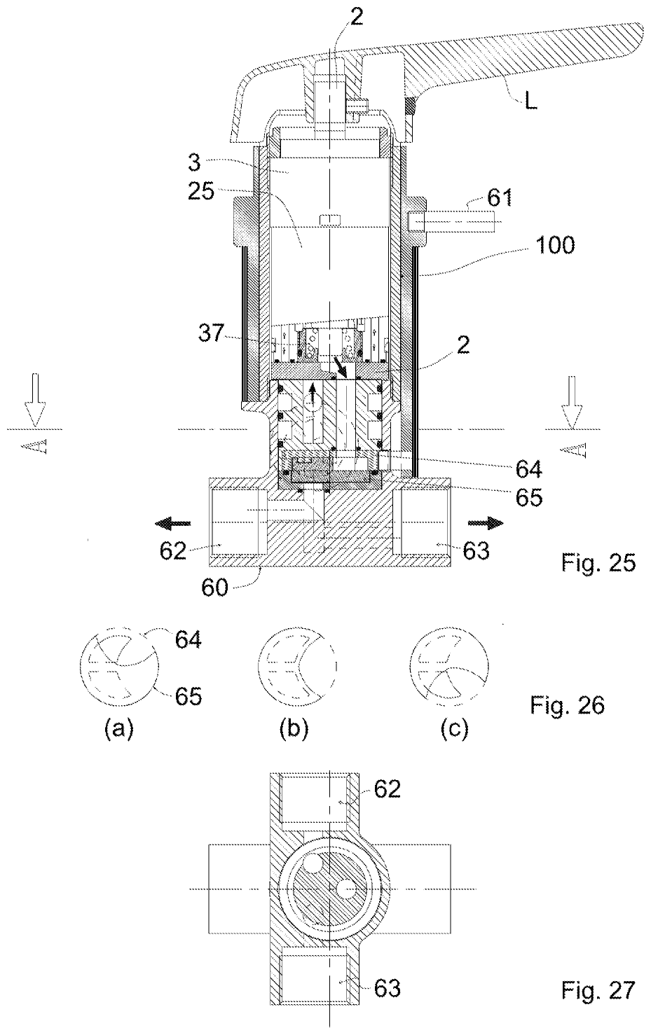

FIG. 25 is a sectional longitudinal view of the mixer 100 equipped with a first accessory 60: it is a flow diverter provided with a control 61 operable by the user to divert the flow of mixed water M selectively to a first outlet 62 or a second outlet 63. The flow diverter 60 is positioned downstream of the base 2, precisely right below the base 2, and comprises perforated discs overlapping and rotatable one with respect to the other.

FIG. 26 schematically shows the possible configurations of the discs 64-65. FIG. 26(a) shows the discs 64-65 arranged to allow the delivery of the mixed water M through the outlet 62, like in FIG. 25; FIG. 26(b) shows the discs 64-65 arranged to prevent the delivery of the mixed water M; FIG. 26(c) shows the discs 64-65 arranged to allow the delivery of the mixed water M through the outlet 63.

FIG. 27 is a flat sectional view of the flow diverter 60, considered in the plane A-A depicted in FIG. 25.

In the example shown in the figures, the flow diverter 60 is two-way, but generally can also be obtained with 3 or more ways.

FIG. 28 shows a mixer 100 equipped with a second accessory 70, a pressure balancer, in addition or in alternative to the flow diverter 60. The flow rates of hot water H and of cold water C enter the mixer 100 after having gone through the pressure balancer 70. When the pressure of the inflowing hot water and cold water is equal, the floating piston 73 remains in a balanced position and the inflowing rates of hot H and cold C water remain constant. Then, the ratios of hot and cold water to be mixed are not modified and there are no temperature variations in the mixed water M delivered. The position of the floating piston 73 only changes at the varying of the inflowing hot water H and/or cold water C. In fact, if the pressure of the hot water H reaching the balancing chamber 72 increases, the floating piston 73 moves so that to close, more or less markedly, the respective inflow passage of the hot water H, while it opens, more or less markedly, the inflow passage of cold water C on the opposite part. The opposite occurs with an increase in the pressure of the cold water, thus modifying the ratios of the amounts of hot and cold water to anyhow maintain the temperature of the mixed water M delivered constant. Examples of pressure balancers are described in the Italian patent application IT102005901371165 e in WO 2014/033678.

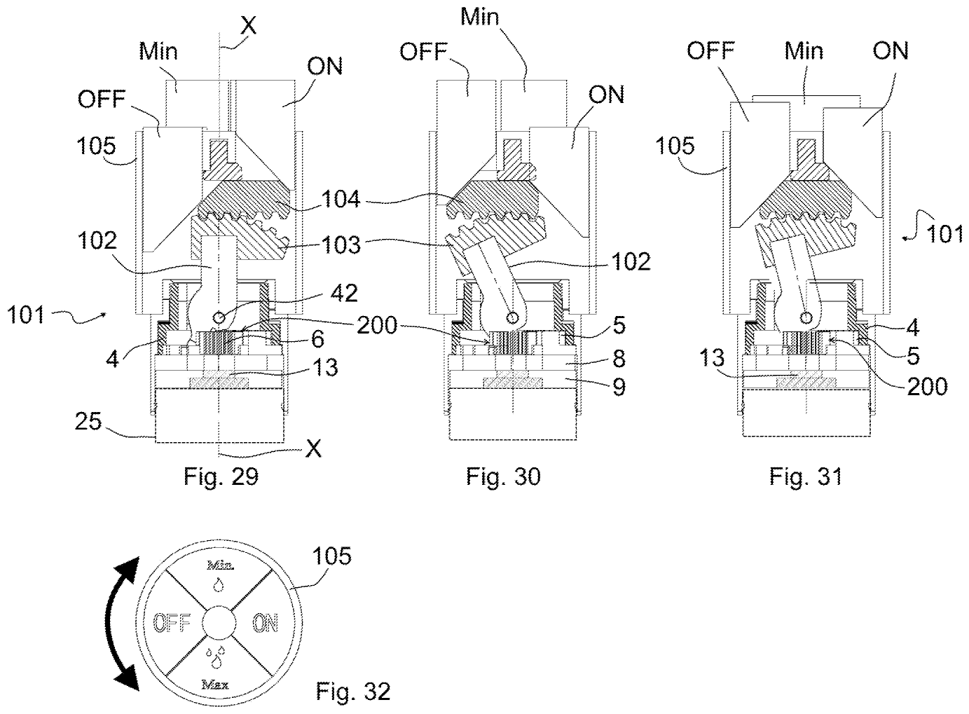

FIGS. 29-31 are sectional longitudinal views, i.e. on a vertical plane containing the axis X-X, of a second embodiment 101 of the mixer according to the invention. For simplicity, FIGS. 29-31 only show the upper part of the mixer 101, the one facing the user and on which there are components that can be handled by the user to operate the mixer. It was thus decided to schematize the body 25 of the mixer 101 with a rectangle shown in a dotted line.

This second embodiment 101 shares the same components as those of the first embodiment 100, from the connection 4 downwards. More in detail, the mixer 101 comprises a fork-shaped control lever 102, like the lever 2, which engages the upper plate 8, as described above with respect to the mixer 100. Unlike the latter, however, the lever 102 is not constrained to a handle M but is provided with a toothed surface 103 on top and which engages a corresponding rack element 104 housed in a knob 105 that can be held by the user.

The knob 105 is rotatable by the user on the longitudinal axis X-X, as denoted by the double arrow in FIG. 32; its rotations are transmitted to the connection 4 of the gear mechanism 200 and thus also to the control lever 102, to the multiplying gear 5 and to the first gear 6, and consequently to the control rod 13 in order to adjust the temperature of the mixed water M in the mixing chamber 37. The knob 105 is thus rotationally integral with the connection 4 of the gear mechanism 200.

There are four buttons 105 named ON, OFF, Min and Max on the knob, intended to be pressed by the user. The OFF button is used to stop the delivery of the mixed water M, the ON button is used to operate the mixer in order to start the delivery of the mixed water M, the button Min is used to limit the flow rate of the mixed water M delivered to the minimum and the button Max is used to adjust the flow rate of the mixed water M delivered to the maximum.

The four OFF, ON, Min and Max buttons interact with the rack element 104 in a way that will be now described, to impart rotation on a vertical plane, especially on a plane containing the axis X-X, to the control lever 102.

The rack element 104 is movable on the relative lying plane, i.e. on a plane orthogonal to the longitudinal axis X-X, inside the knob 105, in both directions, supported by specific guides.

FIG. 29 shows the mixer 101 in the closed configuration: the control lever 102 is aligned with the axis X-X, the OFF button is pressed, the other ON, Min and Max buttons are raised, and the mixer 101 does not deliver water.

FIG. 30 shows the mixer 101 in the open and maximum flow rate of mixed water M delivered configuration: the control lever 102 is tilted with respect to the axis X-X because the ON button was pressed by the user and, when observing the drawing, has caused the displacement of the rack element 104 to the left, by being inserted between the inner surface of the knob 105 and the rack element 104, until making it abut against the OFF button, which corresponds to the travel limit. The tilt imparted to the control lever 102 has caused, as described with reference to the first embodiment 100, the maximum misalignment of the upper plate 8 with respect to the lower plate 9 and has thus brought the two plates 8-9 in one of the configurations shown in FIGS. 11-13: the outflow rate of mixed water M from the mixer 101 is maximum. By rotating the knob 105, the user adjusts the thermostat 20, as previously described. In the example just described, the Max button is dragged by the ON button when it is pressed by the user.

FIG. 31 shows the mixer 101 in the open and modulated, or partial, flow rate of mixed water M delivered configuration: the control lever 102 is less tilted with respect to the axis X-X compared to the configuration shown in FIG. 30 because the Min button was pressed by the user and this involved the partial lowering of the OFF button and the partial raising of the ON button. The rack element 104 is thus pushed by the ON and OFF buttons more to the right with respect to what is shown in FIG. 30, to a more intermediate position, thus reducing the tilt of the control lever 102. The smaller tilt of the control lever 102 corresponds to a smaller misalignment of the upper plate 8 with respect to the lower plate 9: the outflow rate of the mixed water M from the mixer 101 is modulated. By rotating the knob 105, the user adjusts the thermostat 20, as previously described.

By fully pressing on the OFF button, the mixer 101 returns to the configuration shown in FIG. 29.

In practice, both of the embodiments 100 and 101 provide that the adjustment of the temperature of the mixed water M and the adjustment of the flow rate of the mixed water M occur by acting through a single lever, in one case the fork 2 (and handle L connected thereto) and the lever provided with the toothed surface 103 in the other.

1. A thermostatic mixer (100, 101) comprising:
a body (25) having a longitudinal axis (X-X);
manually adjusting means (D) to adjust the inflow rates of hot water (H) and cold water (C) in the mixer (100, 101), operable by a user,
automatic adjusting means (13-15, 17-18, 20, 21) to adjust the temperature of the mixed water (M) delivered by the mixer (100, 101), adjustable by the user,
a single control lever (2, 102) rotatable by the user on a vertical plane parallel to the longitudinal axis (X-X), or containing such axis (X-X), to control the manually adjusting means (D) of the inflow rates of hot water (H) and cold water (C), and rotatable by the user on a horizontal plane orthogonal to the longitudinal axis (X-X) to control the automatic adjusting means (13-15, 17-18, 20, 21) of the temperature of the mixed water (M),
a gear mechanism (200) functionally interposed between the control lever (2, 102) and the automatic adjusting means (13-15, 17-18, 20, 21) of the temperature of the mixed water (M), wherein the gear mechanism (200) defines a gear ratio different from 1:1.

2. Mixer The mixer (100, 101) according to claim 1, wherein the body (25) is internally provided with a water mixing chamber (37), and comprising:
side openings (37′, 37″) provided at different heights of said body (25) with respect to the longitudinal axis (X-X), for the separate supply of hot water (H) and cold water (C) in said mixing chamber (37); and
wherein the flow rates adjusting means (D) comprise at least two overlapping plates (8, 9) provided with canalizations (92′, 92″, 93′, 93″) leading to the side openings (37′, 37″), wherein the canalizations (92′, 92″, 93′, 93″) can be opened and closed depending on the mutual position assumed by the two plates (8, 9) with respect to the longitudinal axis (X-X); and
wherein said automatic adjusting means of the temperature comprise a thermostat (20) active in the mixing chamber (37), and an element (18) for intercepting [[the]] flow rates of hot water (H) and cold water (C), the element being movable along the longitudinal axis (X-X) to completely or partially, and selectively, feedback close said side supply openings (37′, 37″) depending on the expansions suffered by the thermostat (20), and
wherein the control lever (2, 102) is rotatable by the user in said vertical plane to modify the relative radial position of one plate (8) with respect to the other (9) and obtain the manual adjustment of inflow rates of hot water (H) and cold water (C) in the mixing chamber (37), and
wherein the control lever (2, 102) itself is rotatable by the user in said horizontal plane to set a configuration of the automatic adjusting means (18, 20) of the temperature of the mixed water (M), and
wherein said gear mechanism (200) transmits the rotations imparted by the user to the control lever (2, 102) on the horizontal plane to the automatic adjusting means (18, 20), in an amplified way, to adjust the temperature of the mixed water (M).

3. The mixer (100, 101) according to claim 2, wherein first supply passages (33, 34) of hot water (H) leading to a first opening (37′) of the mixing chamber (37) and second supply passages (35, 36) of cold water (C) leading to a second opening (37″) of the mixing chamber (37) are obtained in the body (25), and
wherein said two overlapping plates (8, 9) intercept the first passages (33, 34) and the second passages (35, 36) and
wherein the lower plate (9), immediately adjacent to the body (25) of the mixer (100, 101), is provided with canalizations (92′, 92″, 93′, 93″) in fluidic communication with the first passages (33, 34) and second passages (35, 36) and in fluidic communication with the upper plate (8),
wherein the upper plate (8), stacked on the lower plate (8) on the opposite side of the body (25), is provided with grooves (84, 85) facing the canalizations (92′, 92″, 93′, 93″) of the lower plate (9), and
wherein the control lever (2, 102) engages the upper plate (8) and the rotations imparted to the control lever (2, 102) in a vertical plane cause the upper plate (8) to slip in a radial direction with respect to the lower plate (9).

4. The mixer (100, 101) according to claim 3, wherein, in response to the rotations imparted to the control lever (2, 102) on the vertical plane, the upper plate (8) is movable with respect to the lower plate (9) between:
an open position, at which the grooves (84, 85) of the upper plate (8) are aligned to the canalizations (92′, 92″, 93′, 93″) of the lower plate (9), putting them in fluidic communication and allowing the passage of maximum flow rates of hot water (H) and cold water (C) towards the mixing chamber (37),
a closed position, at which the grooves (84, 85) of the upper plate (8) are misaligned with respect to the canalizations (92′, 92″, 93′, 93″) of the lower plate (9), preventing passage of hot water (H) and cold water (C) towards the mixing chamber (37),
an intermediate position, at which the grooves (84, 85) of the upper plate (8) are partially aligned to the canalizations (92′, 92″, 93′, 93″) of the lower plate (9), putting them in fluidic communication and allowing the passage of modulated flow rates of hot water (H) and cold water (C) towards the mixing chamber (37).

5. The mixer (100, 101) according to claim 2, wherein the control lever (2, 102) is pivoted on an axis orthogonal to the longitudinal axis (X-X) and has at least one portion or leg (2′) to be inserted in a corresponding seat (82) obtained in the upper plate (8).

6. The mixer (100, 101) according to claim 2, wherein the control lever (2, 102) is fork-shaped and has two legs (2′, 2″) engaging corresponding seats (82, 83) obtained in the upper plate (8) on opposite sides with respect to the longitudinal axis (X-X).

7. The mixer (100, 101) according to claim 2, wherein the element (18) for intercepting flow rates of hot water (H) and cold water (C) is a piston fitted on the thermostat (20) and movable with respect to it along the longitudinal axis (X-X).

8. The mixer (100, 101) according to claim 1, wherein:
the body (25) is internally provided with a water mixing chamber (37), in turn provided with side openings (37′, 37″) provided at different heights of said body (25) with respect to the longitudinal axis (X-X), for the separate supply of hot water (H) and cold water (C) in said mixing chamber (37),
said automatic adjusting means of the temperature comprise a thermostat (20) active in the mixing chamber (37) and an element (18) for intercepting the flow rates of hot water (H) and cold water (C), the element being movable along the longitudinal axis (X-X) to completely or partially, and selectively, feedback close said supplying side openings (37, 37″) depending on the expansions suffered by the thermostat (20),
wherein the thermostat (20) comprises a telescopic shaft (40) extending cantileverly in the mixing chamber (37), along the longitudinal axis (X-X), and moving in response to the expansions of the thermostat (20) caused by the water in the mixing chamber (37).

9. The mixer (100, 101) according to claim 8, comprising means (13-15, 17, 25′) for limiting the travel of the telescopic shaft (40) of the thermostat (20) between a minimum extension position, a maximum extension position and an intermediate position.

10. The mixer (100, 101) according to claim 9, wherein the rotations imparted to the control lever (2, 102) on said horizontal plane are transmitted, according to said gear ratio, by the gear mechanism (200) to the means (13-15, 17, 25′) for limiting the travel of the telescopic shaft (40) of the thermostat (20).

11. The mixer (100, 101) according to claim 9, wherein each position taken by the telescopic shaft (40) of the thermostat (20) corresponds to a given volume of the mixing chamber (37).

12. The mixer (100, 101) according to claim 9, wherein the means (13-15, 17, 25′) for limiting travel of the telescopic shaft (40) comprise:
a control rod (13) having a lower end inserted in the mixing chamber (37), and
a restraining element (17) in which the telescopic shaft (40) of the thermostat (20) is engaged,
wherein the control rod (13) is rotatable on the longitudinal axis (X-X), with respect to the body (25) of the mixer (100, 101), in response to rotations imparted by the user to the control lever (2, 102) on a plane orthogonal to the longitudinal axis (X-X) and transmitted to the control rod (13) according to the gear ratio defined by said gear mechanism (200), and
wherein the restraining element (17) is movable in two directions along the longitudinal axis (X-X), in response to the clockwise and counterclockwise rotations of the control rod (13).

13. The mixer (100, 101) according to claim 12, wherein the means (13-15, 17, 25′) for limiting the travel of the telescopic shaft (40) further comprise a hollow screw element (15) and a first elastic element (14), and wherein
a first portion of the screw element (15) is screwed in the lower end of the control rod (13),
a second portion of the screw element (15) is outside of the control rod (13) and abuts against the inner surface of the mixing chamber (37), without being able to rotate, so that the rotations imparted to the control rod (13) in both directions cause the screwing and unscrewing of the restraining element (17) in/out of the control rod (13),
the restraining element (17) is slidingly housed in the screw element (15), facing the thermostat (20), and the first elastic element (14) is interposed between the screw element (15) and the restraining element (17) to hinder its longitudinal movements.

14. The mixer (100, 101) according to claim 12 or claim 13, wherein the gear mechanism (200) is arranged between the control rod (13) and the control lever (2, 102) to transmit the rotations of the control lever (2, 102) to the control rod (13) on a horizontal plane.

15. The mixer (100, 101) according to claim 12, wherein the gear mechanism (200) comprises:
a toothed connection (4) assembled on the body (25) of the thermostat, rotatable on the longitudinal axis (X-X), to which the control lever (2, 102) is pivoted so as to be able to swing on an axis orthogonal to the longitudinal axis;
a first gear (6) of the control rod (13);
a multiplying gear (5) functionally interposed between the toothed connection (4) and the first gear (6), and
wherein the toothed connection (4) and the control lever (2, 102) rotate integrally on a horizontal plane, and the lever is rotatable with respect to the toothed connection (4) on a vertical plane, and
the rotations of the control rod (2, 102), on a horizontal plane, are transmitted by the control rod depending on the gear ratio defined by ratio between the number of teeth of the first gear (6) and the number of teeth of the multiplying gear (5).

16. The mixer (100, 101) according to claim 15, wherein the multiplying gear (5) has half the teeth of the first gear (6), i.e. the gear ratio is 1:2.

17. The mixer (100, 101) according to claim 15, wherein the toothed connection (4) is substantially cylindrical, the inner toothing is obtained at the lower edge and the control lever (2, 102) is constrained to the toothed connection (4) by means of at least one radial pin (42).

18. The mixer (100, 101) according to claim 15, wherein the toothed connection (4) is assembled on the body (25) of the mixer (100, 101) and contains the first gear (6), the multiplying gear (5) and the control lever (2, 102).

19. The mixer (100, 101) according to claim 1, wherein:
the control lever (2) is fastened to a handle (L) the user can hold and rotatable both on the longitudinal axis (X-X) for adjusting the automatic temperature adjusting means and on a plane containing the longitudinal axis (X-X), or parallel thereto, for adjusting the flow rate of mixed water (M) delivered, or
the control lever (102) is provided with a toothed surface (104) and the mixer (101) further comprises a knob (105) rotatable by the user on the longitudinal axis (X-X) to engage the gear mechanism (200) and adjust the automatic temperature adjusting means, a rack element (104) functionally coupled with the toothed surface (104) of the control lever (102), to rotate it, and housed in the knob (105) and translatable in a plane orthogonal to the longitudinal axis (X-X) in response to thrusts imparted by the user by means of the buttons (ON, OFF, Min, Max) on the knob (105) itself, for adjusting the flow rate of mixed water (M).
